(19) United States
(12) Patent Application Publication
(10) Pub. No.: US 2025/0309402 A1
(43) Pub. Date: Oct. 2, 2025

(54) BATTERY

(71) Applicants: TOYOTA JIDOSHA KABUSHIKI KAISHA, Toyota-shi (JP); AISIN CORPORATION, Kariya (JP)

(72) Inventors: Motokuni MARUHASHI, Toyota-shi (JP); Takayuki SUGIYAMA, Toyota-shi (JP); Hiromasa TANAKA, Okazaki-shi (JP); Akio UOTANI, Toyota-shi (JP); Kazuya KUMAZAWA, Nagoya-shi (JP); Masafumi YOSHIDA, Kariya-shi (JP); Shimpei TANAKA, Kariya-shi (JP); Ryohei FUKUOKA, Kariya-shi (JP)

(73) Assignees: TOYOTA JIDOSHA KABUSHIKI KAISHA, Toyota-shi (JP); AISIN CORPORATION, Kariya (JP)

(21) Appl. No.: 19/059,585

(22) Filed: Feb. 21, 2025

(30) Foreign Application Priority Data
Mar. 27, 2024 (JP) 2024-051578

(51) Int. Cl. H01M 10/6556; H01M 10/613; H01M 10/647; H01M 10/6568; H01M 50/209

(52) U.S. Cl. CPC H01M 10/6556; H01M 10/613; H01M 10/647; H01M 10/6568; H01M 50/209

(57) ABSTRACT

A battery includes a first cell stack and a second cell stack arranged side by side, and a first cooling pipe and a second cooling pipe provided below the first and second cell stacks, respectively, and configured to cool the first and second cell stacks, respectively. The first and second cooling pipes extend from first ends of the first and second cell stacks to second ends thereof, respectively, and are connected to each other at the second ends. An inlet port and an outlet port for a refrigerant flowing through the first and second cooling pipes are both provided at the first ends, and the refrigerant flowing in from the inlet port first passes through the first cooling pipe from the first end, then passes through the second cooling pipe from the second end, and flows out from the outlet port.

### CROSS REFERENCE TO RELATED APPLICATIONS

This application is based upon and claims the benefit of priority from Japanese patent application No. 2024-051578, filed on Mar. 27, 2024, the disclosure of which is incorporated herein in its entirety by reference.

### BACKGROUND

The present disclosure relates to a battery.

In a battery in related art, a terminal is provided on the upper surface of each stacked rectangular cell. Recently, as disclosed in Patent Literature 1, a battery in which a terminal is provided on the end face in the longitudinal direction of each stacked rectangular cell has been developed.
Patent Literature 1: United States Patent Publication No., 2022/0302533

### SUMMARY

The inventors of the present application are developing a battery in which a each of a plurality of cell stacks arranged side by side is cooled by a respective one of a plurality of cooling pipes which respectively extend in the longitudinal direction of the plurality of cell stacks. The inventors have found a problem that in such a battery, when a refrigerant is simply fed from one end of each of all the cooling pipes to the other end thereof in parallel with each other, the pressure loss of the refrigerant increases, so that the cell stacks cannot be uniformly cooled.

The present disclosure has been made in view of the above-described circumstances, and provides a battery capable of reducing the pressure loss of a refrigerant flowing therethrough and thereby cooling a cell stack uniformly.

A battery according to an aspect of the present disclosure includes:
a first cell stack and a second cell stack arranged side by side; and
a first cooling pipe and a second cooling pipe provided below the first and second cell stacks, respectively, and configured to cool the first and second cell stacks, respectively, in which
the first and second cooling pipes extend from first ends of the first and second cell stacks to second ends thereof, respectively, and are connected to each other at the second ends,
an inlet port and an outlet port for a refrigerant flowing through the first and second cooling pipes are both provided at the first ends, and
the refrigerant flowing in from the inlet port first passes through the first cooling pipe from the first end, then passes through the second cooling pipe from the second end, and flows out from the outlet port.

In the battery according to the present disclosure, a refrigerant flowing in from the inlet port first passes through the first cooling pipe from the first end, then passes through the second cooling pipe from the second end, and flows out from the outlet port. Therefore, it is possible to reduce the pressure loss of the refrigerant and thereby cool the cell stacks more uniformly compared with a configuration in which the refrigerant is made to flow from the first ends of first and second cooling pipes to the second ends thereof in parallel with each other.

In each of the first and second cell stacks, a plurality of rectangular cells may be stacked on one another; terminals may be provided on both end faces in a longitudinal direction of each of the plurality of rectangular cells; a pair of first cooling pipes may be provided at both ends in a width direction of the first cell stack; and a pair of second cooling pipes may be provided at both ends in a width direction of the second cell stack. By the above-described configuration, the cell stacks can be efficiently and uniformly cooled.

Each of the pair of first cooling pipes and the pair of second cooling pipes may be formed so as to extend from the first end to the second end, from the second end to the first end, and then from the first end to the second end again so as to form a Z-shape between the first and second ends. Note that in each of the pair of first cooling pipes, the refrigerant may flow from an end in a width direction of the first cell stack toward a center thereof, and in each of the pair of second cooling pipes, the refrigerant may flow from an end in a width direction of the second cell stack toward a center thereof. By the above-described configuration, the cell stacks can be cooled more uniformly.

The battery may include a plurality of first cell stacks and a plurality of second cell stacks. Note that the numbers of the first and second cell stacks may be equal to each other. By the above-described configuration, the pressure loss of the refrigerant is reduced, so that the cell stacks can be efficiently and uniformly cooled.

The battery may further include a case configured to house the first and second cell stacks, and the first and second cooling pipes may be disposed below a bottom plate of the case.

According to the present disclosure, it is possible to provide a battery capable of reducing the pressure loss of a refrigerant flowing therethrough and thereby cooling a cell stack uniformly.

The above and other objects, features and advantages of the present disclosure will become more fully understood from the detailed description given hereinbelow and the accompanying drawings.

### BRIEF DESCRIPTION OF DRAWINGS

FIG. 1 is a schematic cross-sectional view showing a battery according to a first embodiment;

FIG. 2 is a schematic perspective view showing a cell stack CS1 in the battery according to the first embodiment;

FIG. 3 is a schematic perspective view showing the cell stack CS1 in the battery according to the first embodiment;

FIG. 4 is an enlarged cross-sectional view of an area IV shown in FIG. 1;

FIG. 5 is a schematic plan view showing a planar configuration of cooling pipes CP1 and CP2 according to the first embodiment; and

FIG. 6 is a schematic plan view showing a planar configuration of cooling pipes CP1 and CP2 according to a comparative example.

### DESCRIPTION OF EMBODIMENTS

Specific embodiments according to the present disclosure will be described hereinafter in detail with reference to the drawings. However, the present disclosure is not limited to the following embodiments. Further, for the clarification of the description, the following descriptions and the drawings are simplified as appropriate.

### First Embodiment

### <Configuration of Battery>

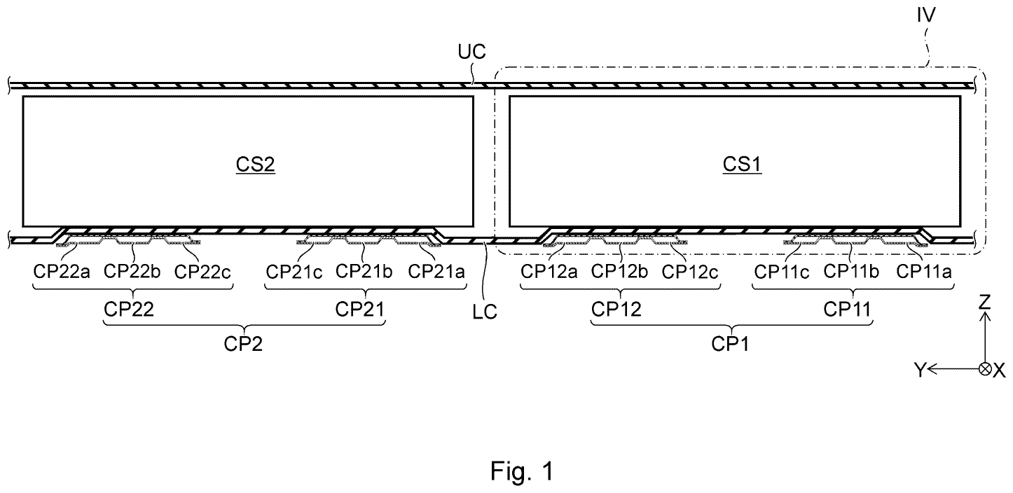

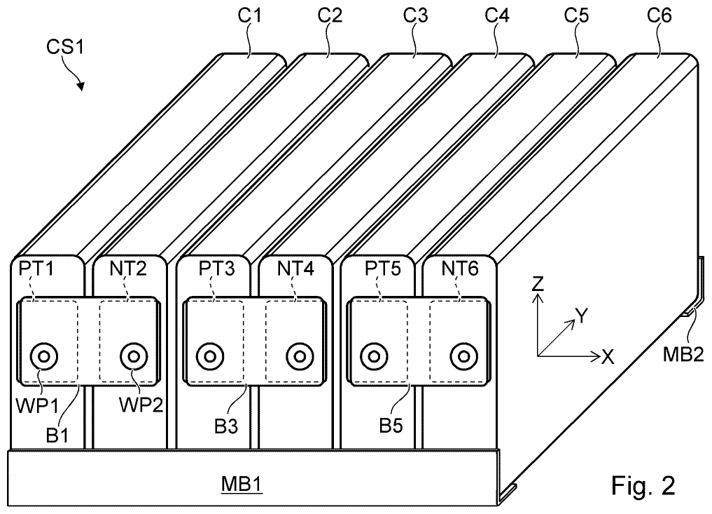

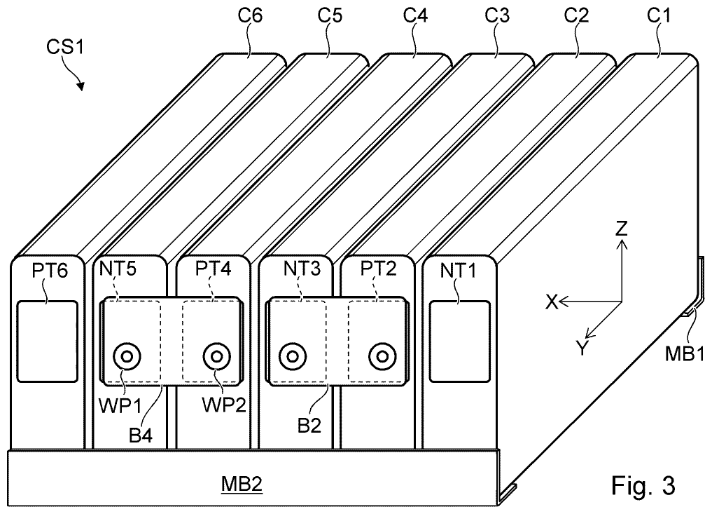

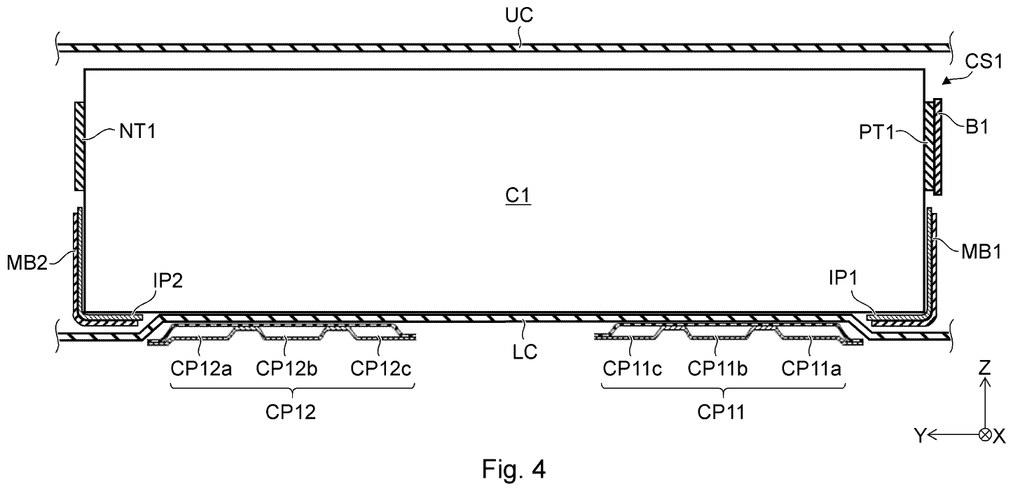

Firstly, a configuration of a battery according to a first embodiment will be described with reference to FIGS. 1 to 4. FIG. 1 is a schematic cross-sectional view showing the battery according to the first embodiment. Each of FIGS. 2 and 3 is a schematic perspective views showing a cell stack CS1 in the battery according to the first embodiment. FIG. 4 is an enlarged cross-sectional view of an area IV shown in FIG. 1.

The battery according to this embodiment is used, for example, as a vehicle-mounted battery or the like. The vehicle in which the battery according to this embodiment is mounted is not limited to any particular vehicle. For example, the vehicle is an electric vehicle, a hybrid vehicle, a fuel cell vehicle, or the like that can be driven by electric power supplied from the battery.

Note that needless to say, the right-handed XYZ orthogonal coordinate system shown in each of FIGS. 1 to 4 and other drawings is shown for the sake of convenience in order to explain the positional relationship among components. In all the drawings such as FIG. 1, in general, the positive direction on the Z-axis is the vertically upward direction, and the XY-plane is parallel to the horizontal plane.

As shown in FIG. 1, the battery according to the first embodiment includes cell stacks CS1 and CS2, an upper case UC, a lower case LC, and cooling pipes CP1 and CP2. As shown in FIG. 1, the cooling pipe CP1 includes a pair of cooling pipes CP11 and CP12, and the cooling pipe CP2 includes a pair of cooling pipes CP21 and CP22.

In FIG. 1, the cell stacks CS1 and CS2 extend in the X-axis direction. Further, as shown in FIG. 1, the cell stacks CS1 and CS2 are arranged side by side in the Y-axis direction inside the case (i.e., between the upper case UC and the lower case LC).

Note that in FIG. 1, instead of cross-sectional views, side views of the cell stacks CS1 and CS2 are shown.

Note that since the cell stacks CS1 and CS2 have configurations similar to each other, the configuration of the cell stack CS1 will be described with reference to FIGS. 2 to 4. As shown in FIGS. 2 and 3, the cell stack CS1 includes rectangular cells C1 to C6, bus bars B1 to B5, and metal bands MB1 and MB2, and also includes insulating plates IP1 and IP2 as shown in FIG. 4.

Note that in FIG. 4, instead of cross-sectional views, side views of the rectangular cell C1 are shown.

As shown in FIGS. 2 and 3, the rectangular cells C1 to C6 are rectangular cells each having a rectangular parallelepiped shape extending in the Y-axis direction. The rectangular cells C1 to C6 are stacked on one another in the thickness direction (X-axis direction) and thereby form the cell stack CS1. Each of the rectangular cells C1 to C6 is, for example, a secondary battery such as a lithium-ion battery or a nickel-metal hydride battery.

Note that, in FIGS. 2 and 3, the cell stack CS1 is shown in a simplified manner. Although the cell stack CS1 shown in FIGS. 2 and 3 is formed of six of the rectangular cells C1 to C6, it is usually formed of more rectangular cells. In fact, the number of rectangular cells forming the cell stack CS1 is not limited to any particular number, and may be any number of two or more.

Further, a heat insulating plate, a spacer for adjusting a distance between rectangular cells adjacent to each other, and/or the like (not shown) may be inserted between rectangular cells adjacent to each other.

Further, end plates (not shown) may be provided at both ends in the stacking direction (X-axis direction) of the cell stack CS1.

As shown in FIG. 2, a positive electrode terminal PT1 is provided on one end face (an end face on the Y-axis negative side) of the rectangular cell C1 in the longitudinal direction thereof. The positive electrode terminal PT1 shown in FIG. 2 has a rectangular shape in the XZ plan view and is provided so as to protrude outward from the end face of the rectangular cell C1. However, the present disclosure is not particularly limited thereto. Further, the positive electrode terminal PT1 shown in FIG. 2 is provided on the upper side (the Z-axis positive side) of the end face of the rectangular cell C1. The positive electrode terminal PT1 is made of, for example, a metal material such as copper having excellent electrical conductivity.

Similarly, as shown in FIG. 2, a negative electrode terminal NT2 is provided on one end face (an end face on the Y-axis negative side) of the rectangular cell C2 adjacent to the rectangular cell C1 in the longitudinal direction thereof. A positive electrode terminal PT3 is provided on one end face (an end face on the Y-axis negative side) of the rectangular cell C3 adjacent to the rectangular cell C2 in the longitudinal direction thereof. A negative electrode terminal NT4 is provided on one end face (an end face on the Y-axis negative side) of the rectangular cell C4 adjacent to the rectangular cell C3 in the longitudinal direction thereof. A positive electrode terminal PT5 is provided on one end face (an end face on the Y-axis negative side) of the rectangular cell C5 adjacent to the rectangular cell C4 in the longitudinal direction thereof. A negative electrode terminal NT6 is provided on one end surface (an end face on the Y-axis negative side) of the rectangular cell C6 adjacent to the rectangular cell C5 in the longitudinal direction thereof.

As shown in FIG. 2, each of the negative electrode terminal NT2 of the rectangular cell C2, the positive electrode terminal PT3 of the rectangular cell C3, the negative electrode terminal NT4 of the rectangular cell C4, the positive electrode terminal PT5 of the rectangular cell C5, and the negative electrode terminal NT6 of the rectangular cell C6 has a shape similar to that of the positive electrode terminal PT1 of the rectangular cell C1, and they are disposed in a manner similar to that in which the positive electrode terminal PT1 of the rectangular cell C1 is disposed.

Further, as shown in FIG. 2, the positive electrode terminal PT1 of the rectangular cell C1 and the negative electrode terminal NT2 of the rectangular cell C2, which are disposed so as to be adjacent to each other, are electrically connected to each other by the plate-like bus bar B1. Similarly, the positive electrode terminal PT3 of the rectangular cell C3 and the negative electrode terminal NT4 of the rectangular cell C4, which are disposed so as to be adjacent to each other, are electrically connected to each other by the bus bar B3 of plate-like. Similarly, the positive electrode terminal PT5 of the rectangular cell C5 and the negative electrode terminal NT6 of the rectangular cell C6, which are disposed so as to be adjacent to each other, are electrically connected by the plate-like bus bar B5.

Meanwhile, as shown in FIG. 3, a negative electrode terminal NT1 is provided on the other end face (an end face on the Y-axis positive side) of the rectangular cell C1 in the longitudinal direction thereof. Like the positive electrode terminal PT1 shown in FIG. 2, the negative electrode terminal NT1 shown in FIG. 3 has a rectangular shape in the XZ plan view and is provided so as to protrude outward from the end face of the rectangular cell C1. However, the present disclosure is not particularly limited thereto. Further, like the positive electrode terminal PT1 shown in FIG. 2, the negative electrode terminal NT1 shown in FIG. 3 is provided on the upper side (the Z-axis positive side) of the end face of the rectangular cell C1. Like the positive electrode terminal PT1, the negative electrode terminal NT1 is made of a metal material such as copper having excellent electrical conductivity.

Similarly, as shown in FIG. 3, a positive electrode terminal PT2 is provided on the other end face (an end face on the Y-axis positive side) of the rectangular cell C2 adjacent to the rectangular cell C1 in the longitudinal direction thereof. A negative electrode terminal NT3 is provided on the other end face (an end face on the Y-axis positive side) of the rectangular cell C3 adjacent to the rectangular cell C2 in the longitudinal direction thereof. A positive electrode terminal PT4 is provided on the other end face (an end face on the Y-axis positive side) of the rectangular cell C4 adjacent to the rectangular cell C3 in the longitudinal direction thereof. A negative electrode terminal NT5 is provided on the other end face (an end face on the Y-axis positive side) of the rectangular cell C5 adjacent to the rectangular cell C4 in the longitudinal direction thereof. A positive electrode terminal PT6 is provided on the other end face (an end face on the Y-axis positive side) of the rectangular cell C6 adjacent to the rectangular cell C5 in the longitudinal direction thereof.

As shown in FIG. 3, each of the positive electrode terminal PT2 of the rectangular cell C2, the negative electrode terminal NT3 of the rectangular cell C3, the positive electrode terminal PT4 of the rectangular cell C4, the negative electrode terminal NT5 of the rectangular cell C5, and the positive electrode terminal PT6 of the rectangular cell C6 has a shape similar to that of the negative electrode terminal NT1 of the rectangular cell C1, and they are disposed in a manner similar to that in which the negative electrode terminal NT1 of the rectangular cell C1 is disposed.

Further, as shown in FIG. 3, the positive electrode terminal PT2 of the rectangular cell C2 and the negative electrode terminal NT3 of the rectangular cell C3, which are disposed so as to be adjacent to each other, are electrically connected to each other by the plate-like bus bar B2. Similarly, the positive electrode terminal PT4 of the rectangular cell C4 and the negative electrode terminal NT5 of the rectangular cell C5, which are disposed so as to be adjacent to each other, are electrically connected to each other by the plate-like bus bar B4. As described above, in the cell stack CS1 shown in FIGS. 2 and 3, the rectangular cells C1 to C6 are connected to each other in series by the bus bars B1 to B5.

Note that the negative electrode terminal NT1 of the rectangular cell C1 shown in FIG. 3 is connected to the positive electrode terminal of another cell stack through, for example, a bus bar (not shown). However, the present disclosure is not particularly limited thereto. Further, the positive electrode terminal PT6 of the rectangular cell C6 shown in FIG. 3 is connected to the negative electrode terminal of yet another cell stack through, for example, a bus bar (not shown). However, the present disclosure is not particularly limited thereto. By the above structure, for example, a plurality of cell stacks can be connected to each other in series.

Since the bus bars B1 to B5 shown in FIGS. 2 and 3 have structures similar to each other, the bus bar B1 will be described.

As shown in FIG. 2, the bus bar B1 is a plate-like member that electrically connects the positive electrode terminal PT1 of the rectangular cell C1 to the negative electrode terminal NT2 of the rectangular cell C2 which are disposed so as to be adjacent to each other. The bus bar B1 is made of, for example, a metal material such as copper having excellent electrical conductivity.

As shown in FIG. 2, the bus bar B1 is, for example, a plate-like member having a rectangular shape in the XZ-plan view. The bus bar B1 is provided so as to cover roughly the entire positive terminal PT1 of the rectangular cell C1 and the entire negative terminal NT2 of the rectangular cell C2. The bus bar B1 includes a pair of welding parts WP1 and WP2 welded to the positive terminal PT1 of the rectangular cell C1 and the negative terminal NT2 of the rectangular cell C2, respectively, which are arranged adjacent to each other.

The welding parts WP1 and WP2 shown in FIG. 2 are provided near both ends in the X-axis direction of the bus bar B1 at the lower part thereof (i.e., the part on the Z-axis negative side thereof). However, the positions of the welding parts WP1 and WP2 are not limited to any particular place. Note that FIG. 2 shows the welding parts WP1 and WP2 before they are welded. The welding parts WP1 and WP2 shown in FIG. 2 are countersunk, so that the areas of the bus bar in which they are provided are thinner than the remaining area, i.e., the area therearound, of the bus bar. Further, each of the welding parts WP1 and WP2 shown in FIG. 2 has a circular shape in the XZ-plan view, and a through hole is formed at its center.

The welding method is not limited to any particular method. For example, the bus bar B1 is welded to the positive terminal PT1 of the rectangular cell C1 at the welding part WP1 by applying a laser beam to the welding part WP1 from the Y-axis negative side thereof. Similarly, the bus bar B1 is welded to the negative terminal NT2 of the rectangular cell C2 at the welding part WP2 by applying a laser beam to the welding part WP2 from the Y-axis negative side thereof.

As shown in FIGS. 2 and 3, the metal bands MB1 and MB2 are metal members each of which has an L-shape in YZ-cross section and extends over the entire length of the cell stack CS1 in the stacking direction. The metal bands MB1 and MB2 band bind, i.e., retain, both lower ends in the longitudinal direction of the rectangular cells C1 to C6 (i.e., the cell stack CS1).

Note that the metal bands MB1 and MB2 may be divided into a plurality of sections, and the plurality of sections are arranged over the entire length of the cell stack CS1.

More specifically, as shown in FIG. 4, the metal band MB1 is provided in an L-shape in YZ-cross section along the lower corners on the Y-axis negative side of the rectangular cells C1 to C6, and includes a bottom plate that supports the bottom surfaces of the rectangular cells C1 to C6 and a side plate that supports the end faces of the rectangular cells C1 to C6. Similarly, the metal band MB2 is provided in an L-shape in YZ-cross section along the lower corners on the Y-axis positive side of the rectangular cells C1 to C6, and includes a bottom plate that supports the bottom surfaces of the rectangular cells C1 to C6 and a side plate that supports the end faces of the rectangular cells C1 to C6.

As shown in FIG. 4, the insulating plate IP1 is provided between the rectangular cells C1 to C6 and the metal band MB1 at the respective lower corners on the Y-axis negative side of the rectangular cells C1 to C6, and electrically insulates the rectangular cells C1 to C6 from the metal band MB1. That is, the insulating plate IP1 is an insulating member having an L-shape in YZ-cross section and extending over the entire length of the cell stack CS1 in the stacking direction.

Similarly, the insulating plate IP2 is provided between the rectangular cells C1 to C6 and the metal band MB2 at the respective lower corners on the Y-axis positive side of the rectangular cells C1 to C6, and electrically insulates the rectangular cells C1 to C6 from the metal band MB2. That is, the insulating plate IP2 is an insulating member having an L-shape in YZ-cross section and extending over the entire length of the cell stack CS1 in the stacking direction.

The insulating plates IP1 and IP2 are made of, for example, a resin. The insulating plates IP1 and IP2 shown in FIG. 4 have L-shapes in YZ-cross section corresponding to the shapes of the metal bands MB1 and MB2, respectively, are slightly larger than the metal bands MB1 and MB2, respectively, and are disposed so as to protrude from the metal bands MB1 and MB2, respectively. However, the shapes and sizes of the insulating plates IP1 and IP2 are not limited to any particular shapes and sizes.

It should be noted that the insulating plates IP1 and IP2 are not indispensable as long as the rectangular cells C1 to C6 and the metal bands MB1 and MB2 can be electrically insulated from each other.

The description will be continued by referring to FIG. 1 again.

As shown in FIG. 1, the upper case UC and the lower case LC form a case for housing the cell stacks CS1 and CS2. The upper case UC is a metal plate covering the upper surfaces of the cell stacks CS1 and CS2, and the lower case LC is a metal plate supporting the bottom surfaces of the cell stacks CS1 and CS2. The bottom surfaces of the cell stacks CS1 and CS2 (i.e., the rectangular cells C1 to C6) and the upper surface of the lower case LC are electrically insulated by, for example, a thermally conductive layer having an insulating property (not shown).

As shown in FIG. 1, the cooling pipe (first cooling pipe) CP1 cools the cell stack (first cell stack) CS1. The cooling pipe (second cooling pipe) CP2 cools the cell stack (second cell stack) CS2. As shown in FIG. 1, the cooling pipes CP1 and CP2 extend over the entire length of the cell stacks CS1 and CS2 in the stacking direction (X-axis direction) while being in contact with the bottom surface of the lower case LC.

Note that the cooling pipes CP1 and CP2 may be provided above the bottom surface of the lower case LC, i.e., inside the case, as long as the cell stacks CS1 and CS2 can be cooled from below by the cooling pipes CP1 and CP2, respectively.

The refrigerant flowing in the cooling pipes CP1 and CP2 is, for example, water.

As will be described later in detail, the inlet port and outlet port for the refrigerant flowing through the cooling pipes CP1 and CP2 shown in FIG. 1 are both disposed on the first end side (the end side on X-axis negative side) of the cell stacks CS1 and CS2. Further, the cooling pipes CP1 and CP2 are connected to each other on the second end side (the end side on X-axis positive side) of the cell stacks CS1 and CS2.

Further, the refrigerant flowing in from the inlet port provided at the first end first passes through the cooling pipe CP1 from the first end, then passes through the cooling pipe CP2 from the second end, and flows out from the outlet port provided at the first end.

As will be described later in detail, the battery according to this embodiment can reduce the pressure loss of the refrigerant more and thereby cool the cell stacks CS1 and CS2 more uniformly than in the configuration in which the refrigerant flows from the first ends of both the cooling pipes CP1 and CP2 to the second ends thereof in parallel with each other.

### <Detailed Configuration of Cooling Pipes CP1 and CP2>

A detailed configuration of the cooling pipes CP1 and CP2 will be described hereinafter.

As shown in FIG. 1, the cooling pipe CP1 includes a pair of cooling pipes CP11 and CP12 provided at both ends in the width direction of the cell stack CS1. Similarly, the cooling pipe CP2 includes a pair of cooling pipes CP21 and CP22 provided at both ends in the width direction of the cell stack CS2.

Each of the pair of cooling pipes CP11 and CP12 and the pair of cooling pipes CP21 and CP22 shown in FIG. 1 is formed by bonding two metal plates each having projections and recesses to each other. However, the structures of the cooling pipes are not limited to any particular structures. For example, a metal plate made of aluminum, an aluminum alloy, copper, a copper alloy, or the like, all of which have an excellent thermal conductivity, is used. When the battery is used as a vehicle-mounted battery or the like, a plate made of an aluminum alloy is preferred in order to reduce the weight.

Note that as shown in FIG. 4, since the terminals (the positive terminal PT1 and the negative terminal NT1 in FIG. 4) are provided on both end faces of the rectangular cells C1 to C6, of which the cell stack CS1 is composed, heat is likely to be generated when a current flows through them. To cope with this heat, a pair of cooling pipes CP11 and CP12 are provided at both ends in the width direction of the cell stack CS1, so that the cell stack CS1 can be efficiently and uniformly cooled. Similarly, a pair of cooling pipes CP21 and CP22 are provided at both ends in the width direction of the cell stack CS2, so that the cell stack CS2 can be efficiently and uniformly cooled.

The cooling pipe CP11 shown in FIGS. 1 and 4 includes three cooling pipes CP11a, CP11b and CP11c extending in the X-axis direction, though the number of cooling pipes is not limited to three. The three cooling pipes CP11a, CP11b and CP11c are arranged side by side in this order from the Y-axis negative end of the cell stack CS1 (i.e., the rectangular cells C1 to C6) toward the center thereof.

Similarly, the cooling pipe CP12 shown in FIGS. 1 and 4 includes three cooling pipes CP12a, CP12b and CP12c extending in the X-axis direction. The three cooling pipes CP12a, CP12b and CP12c are arranged side by side in this order from the Y-axis positive end of the cell stack CS1 (i.e., rectangular cells C1 to C6) toward the center thereof.

Note that as shown in FIGS. 1 and 4, the cross-sectional shape of each of the cooling pipes CP11a, CP11b and CP11c is a parallelogram or a trapezoid, i.e., a rectangle. Therefore, the contact area between the cooling pipe CP11 and the lower case LC is large, so that the cell stack CS1 can be efficiently cooled. Similarly, the cross-sectional shape of each of the cooling pipes CP12a, CP12b and CP12c is a parallelogram or a trapezoid, i.e., a rectangle. Therefore, the contact area between the cooling pipe CP12 and the lower case LC is large, so that the cell stack CS1 can be efficiently cooled.

The cooling pipe CP21 shown in FIG. 1 includes three cooling pipes CP21a, CP21b and CP21c extending in the X-axis direction, though the number of cooling pipes is not limited to three. The three cooling pipes CP21a, CP21b and CP21c are arranged side by side in this order from the Y-axis negative end of the cell stack CS2 (i.e., rectangular cells C1 to C6) toward the center thereof.

Similarly, the cooling pipe CP22 shown in FIG. 1 includes three cooling pipes CP22a, CP22b and CP22c extending in the X-axis direction. The three cooling pipes CP22a, CP22b and CP22c are arranged side by side in this order from the Y-axis positive end of the cell stack CS2 (i.e., rectangular cells C1 to C6) toward the center thereof.

Note that as shown in FIG. 1, the cross-sectional shape of each of the cooling pipes CP21a, CP21b and CP21c is a parallelogram or a trapezoid, i.e., a rectangle. Therefore, the contact area between the cooling pipe CP21 and the lower case LC is large, so that the cell stack CS2 can be efficiently cooled. Similarly, the cross-sectional shape of each of the cooling pipes CP22a, CP22b and CP22c is a parallelogram or a trapezoid, i.e., a rectangle. Therefore, the contact area between the cooling pipe CP22 and the lower case LC is large, so that the cell stack CS1 can be efficiently cooled.

### <Planar Configuration of Cooling Pipes CP1 and CP2>

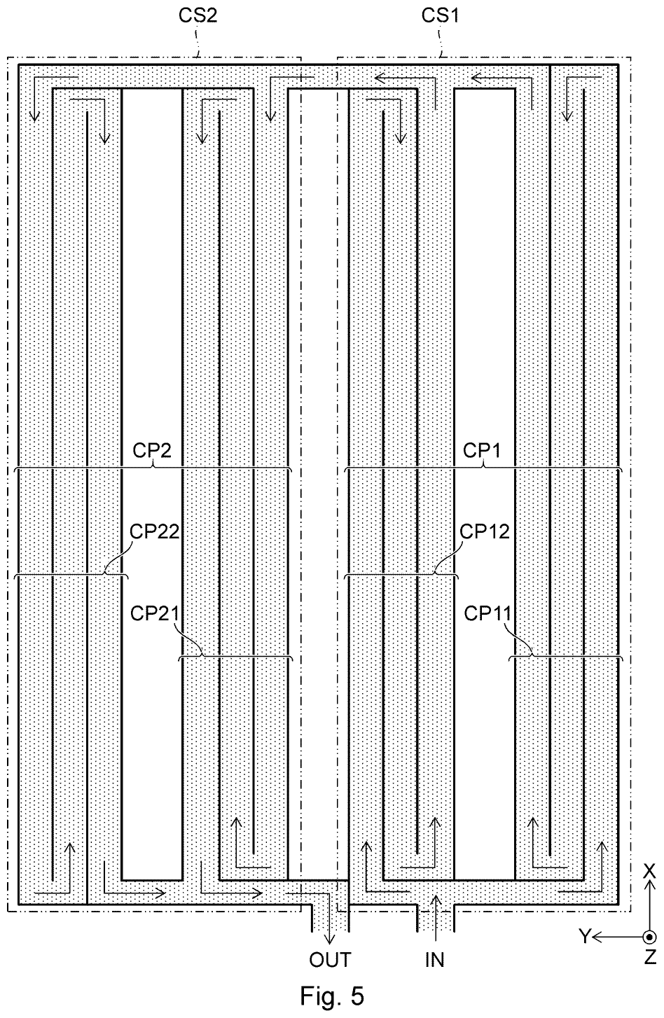

Next, a planar configuration of the cooling pipes CP1 and CP2 will be described with reference to FIG. 5. FIG. 5 is a schematic plan view showing the planar configuration of the cooling pipes CP1 and CP2 according to the first embodiment. That is, FIG. 5 shows piping paths of the cooling pipes CP1 and CP2. In FIG. 5, the cell stacks CS1 and CS2 are shown by two-dot chain lines. Further, arrows shown inside the cooling pipes CP1 and CP2 in FIG. 5 indicate the flow of a refrigerant.

Note that although FIG. 5 is a plan view, the cooling pipes CP1 and CP2 are indicated by dots for easier understanding.

As shown in FIG. 5, an inlet port IN and an outlet port OUT for the refrigerant flowing through the cooling pipes CP1 and CP2 are both provided at the first ends (X-axis negative ends) of the cell stacks CS1 and CS2. Further, the cooling pipes CP1 and CP2 are connected to each other at the second ends (X-axis positive ends) of the cell stacks CS1 and CS2.

Further, as shown in FIG. 5, the refrigerant flowing in from the inlet port IN first passes through the cooling pipes CP11 and CP12 (cooling pipe CP1) from the first end, and then passes through the cooling pipes CP21 and CP22 (cooling pipe CP2) from the second end, and flows out from the outlet port OUT.

That is, the cooling pipe CP1 for cooling the cell stack CS1 and the cooling pipe CP2 for cooling the cell stack CS2 are connected in series with each other, so that the cell stack CS1 is first cooled and then the cell stack CS2 is cooled.

Note that the cooling pipes CP11 and CP12, of which the cooling pipe CP1 is composed, are connected in parallel with each other between the first and second ends. Similarly, the cooling pipes CP21 and CP22, of which the cooling pipe CP2 is composed, are connected in parallel with each other between the first and second ends.

More specifically, as shown in FIG. 5, the cooling pipe CP11 for cooling the cell stack CS1 includes the cooling pipes CP11a, CP11b and CP11c shown in FIGS. 1 and 4, and is formed so as to extend from the first end to the second end, from the second end to the first end, and then from the first end to the second end again so as to form a Z-shape between the first and second ends. That is, the cooling pipe CP11 includes two U-shaped folded parts. Note that the Z-shape can also be regarded as an N-shape.

As shown in FIG. 5, the refrigerant flowing in from the inlet port flows from the first end, passes through the cooling pipes CP11a, CP11b and CP11c shown in FIGS. 1 and 4 in this order, and reaches the second end. By making the refrigerant flow from the end in the width direction of the cell stack CS1 toward the center thereof in the cooling pipe CP11 as described above, the cell stack CS1 can be uniformly and efficiently cooled.

Similarly, as shown in FIG. 5, the cooling pipe CP12 for cooling the cell stack CS1 includes the cooling pipes CP12a, CP12b and CP12c shown in FIGS. 1 and 4, and is formed so as to extend from the first end to the second end, from the second end to the first end, and then from the first end to the second end again so as to form a Z-shape between the first and second ends.

As shown in FIG. 5, the refrigerant flowing in from the inlet port flows from the first end, passes through the cooling pipes CP12a, CP12b and CP12c shown in FIGS. 1 and 4 in this order, and reaches the second end. By making the refrigerant flow from the end in the width direction of the cell stack CS1 toward the center thereof in the cooling pipe CP12 as described above, the cell stack CS1 can be uniformly and efficiently cooled.

Meanwhile, as shown in FIG. 5, the cooling pipe CP21 for cooling the cell stack CS2 includes the cooling pipes CP21a, CP21b and CP21c shown in FIG. 2, and is formed so as to extend from the second end to the first end, from the first end to the second end, and then from the second end to the first end again so as to form a Z-shape between the first and second ends.

As shown in FIG. 5, the refrigerant that has passed through the cooling pipes CP11 and CP12 flows from the second end, passes through the cooling pipes CP21a, CP21b and CP21c shown in FIG. 1 in this order, and flows out from the outlet port OUT provided at the first end. By making the refrigerant flow from the end in the width direction of the cell stack CS2 toward the center thereof in the cooling pipe CP21 as described above, the cell stack CS2 can be uniformly and efficiently cooled.

Similarly, as shown in FIG. 5, the cooling pipe CP22 for cooling the cell stack CS2 includes the cooling pipes CP22a, CP22b and CP22c shown in FIG. 2, and is formed so as to extend from the second end to the first end, from the first end to the second end, and then from the second end to the first end again so as to form a Z-shape between the first and second ends.

As shown in FIG. 5, the refrigerant that has passed through the cooling pipes CP11 and CP12 flows from the second end, passes through the cooling pipes CP22a, CP22b and CP22c shown in FIG. 1 in this order, and flows out from the outlet port OUT provided at the first end. By making the refrigerant flow from the end in the width direction of the cell stack CS2 toward the center thereof in the cooling pipe CP22 as described above, the cell stack CS2 can be uniformly and efficiently cooled.

### Planar Configuration of Cooling Pipes CP1 and CP2 According to Comparative Example

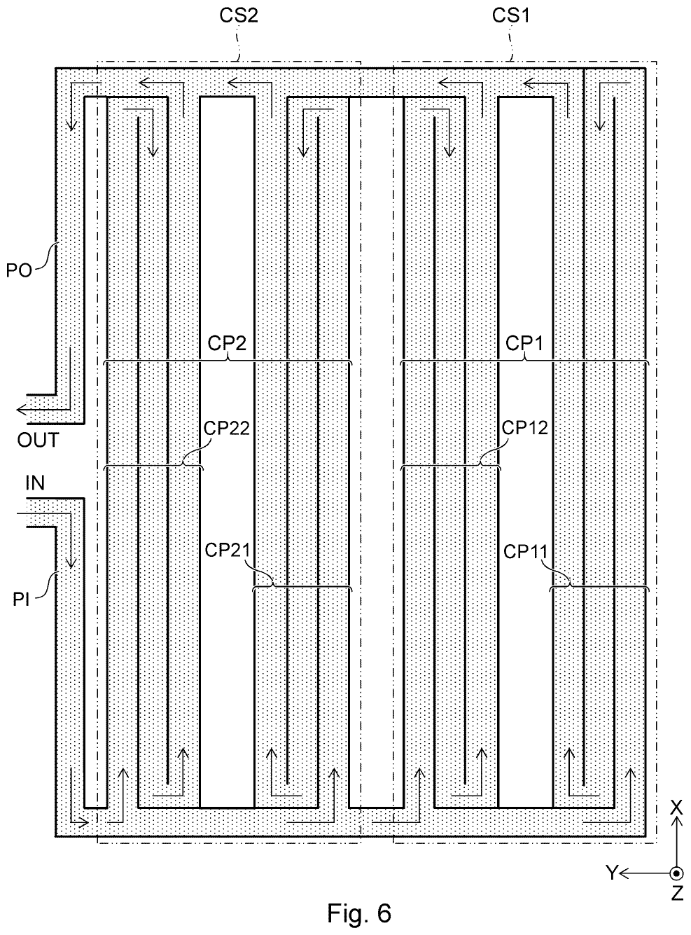

Next, a planar configuration of cooling pipes CP1 and CP2 according to a comparative example will be described with reference to FIG. 6. FIG. 6 is a schematic plan view showing the planar configuration of the cooling pipes CP1 and CP2 according to the comparative example. That is, FIG. 6 shows piping paths of the cooling pipes CP1 and CP2 according to the comparative example. In FIG. 6, the cell stacks CS1 and CS2 are shown by two-dot chain lines. Further, arrows shown inside the cooling pipes CP1 and CP2 in FIG. 6 indicate the flow of a refrigerant.

Note that although FIG. 6 is a plan view, the cooling pipes CP1 and CP2 are indicated by dots for easier understanding.

As shown in FIG. 6, an inlet port IN and an outlet port OUT for the refrigerant flowing through the cooling pipes CP1 and CP2 are both provided at the center in the X-axis negative direction in the outside of the cell stacks CS1 and CS2 arranged side by side. Further, the cooling pipes CP1 and CP2 are connected to each other at both ends in the longitudinal direction (X-axis direction) of the cell stacks CS1 and CS2. Note that as shown in FIG. 6, in the cooling pipes CP1 and CP2 according to the comparative example, an additional inflow pipe PI for connecting the inlet port IN to the first end (X-axis negative end) and an additional outflow pipe PO for connecting the output port OUT to the second end (X-axis positive end) are provided.

Note that although the inlet port IN and the outlet port OUT, which are provided outside the cell stacks CS1 and CS2 arranged side by side, are provided on the Y-axis positive side of the cell stack CS2 in FIG. 6, they may be provided on the Y-axis negative side of the cell stack CS1. Further, the inflow pipe PI may not be provided, and the outflow pipe PO is extended to the first end, so that the inlet port IN and the outlet port OUT are both provided at the first end. Alternatively, the outflow pipe PO may not be provided, and the inflow pipe PI is extended to the second end, so that the inlet port IN and the outlet port OUT are both provided at the second end.

As shown in FIG. 6, the refrigerant flowing in from the inlet port IN flows from the first end, passes through the cooling pipes CP11 and CP12 (cooling pipe CP1) and the cooling pipes CP21 and CP22 (cooling pipe CP2), reaches the second end, and flows out from the outlet port OUT. That is, in the comparative example shown in FIG. 6, the cooling pipe CP1 for cooling the cell stack CS1 and the cooling pipe CP2 for cooling the cell stack CS2 are connected in parallel with each other, and the cell stacks CS1 and CS2 are simultaneously cooled.

As shown in FIG. 6, the cooling pipe CP11 according to the comparative example also includes the cooling pipes CP11a, CP11b and CP11c shown in FIGS. 1 and 4, and is formed so as to extend from the first end to the second end, from the second end to the first end, and then from the first end to the second end again so as to form a Z-shape between the first and second ends. Further, as shown in FIG. 6, the refrigerant flowing in from the inlet port flows from the first end, passes through the cooling pipes CP11a, CP11b and CP11c in this order, and reaches the second end.

Similarly, as shown in FIG. 6, the cooling pipe CP12 according to the comparative example also includes the cooling pipes CP12a, CP12b and CP12c shown in FIGS. 1 and 4, and is formed so as to extend from the first end to the second end, from the second end to the first end, and then from the first end to the second end again so as to form a Z-shape between the first and second ends. Further, as shown in FIG. 6, the refrigerant flowing in from the inlet port flows from the first end, passes through the cooling pipes CP12a, CP12b and CP12c in this order, and reaches the second end.

Similarly, as shown in FIG. 6, the cooling pipe CP21 according to the comparative example also includes the cooling pipes CP21a, CP21b and CP21c shown in FIG. 2, and is formed so as to extend from the first end to the second end, from the second end to the first end, and then from the first end to the second end again so as to form a Z-shape between the first and second ends. Meanwhile, as shown in FIG. 6, in the cooling pipe CP21 according to the comparative example, the refrigerant flowing in from the inlet port flows from the first end, passes through the cooling pipes CP21a, CP21b and CP21c in this order, and reaches the second end.

Similarly, as shown in FIG. 6, the cooling pipe CP22 according to the comparative example also includes the cooling pipes CP21a, CP21b and CP21c shown in FIG. 2, and is formed so as to extend from the first end to the second end, from the second end to the first end, and then from the first end to the second end again so as to form a Z-shape between the first and second ends. Meanwhile, as shown in FIG. 6, in the cooling pipe CP22 according to the comparative example, the refrigerant flowing in from the inlet port flows from the first end, passes through the cooling pipes CP21a, CP21b and CP21c in this order, and reaches the second end.

As described above, in the comparative example shown in FIG. 6, the cooling pipe CP1 for cooling the cell stack CS1 and the cooling pipe CP2 for cooling the cell stack CS2 are connected in parallel with each other, and the cell stacks CS1 and CS2 are simultaneously cooled. Therefore, at a glance, it seems that the cell stacks CS1 and CS2 can be uniformly cooled. However, in reality, in the comparative example, the pressure loss of the refrigerant is large, so that the cell stacks CS1 and CS2 cannot be uniformly cooled. Further, as the number of cell stacks arranged side by side increases, the pressure loss of the refrigerant further increases, so that the uniformity of the cooling further deteriorates.

In contrast, in the embodiment according to the present disclosure shown in FIG. 5, the cooling pipe CP1 for cooling the cell stack CS1 and the cooling pipe CP2 for cooling the cell stack CS2 are connected in series with each other, so that the cell stack CS1 is first cooled and then the cell stack CS2 is cooled. Therefore, the pressure loss of the refrigerant can be more reduced than in the comparative example, so that the cell stacks CS1 and CS2 can be cooled more uniformly.

Further, in this embodiment shown in FIG. 5, the inflow pipe PI and the outflow pipe PO shown in FIG. 6 are unnecessary.

Note that the battery according to this embodiment may include a plurality of cell stacks CS1 in which the refrigerant flows first and hence which is cooled first, and a plurality of cell stacks CS2 in which the refrigerant flows later and hence which is cooled later. In this case, in the battery according to this embodiment, when the numbers of the first and second cell stacks CS1 and CS2 are equal to each other, the cells stack can be efficiently and uniformly cooled.

As described above, in the battery according to this embodiment, the refrigerant flowing in from the inlet port IN first passes through the cooling pipe CP1 for cooling the cell stack CS1 from the first end, and then passes through the cooling pipe CP2 for cooling the cell stack CS2 from the second end, and flows out from the outlet port OUT. Therefore, the battery according to this embodiment can reduce the pressure loss of the refrigerant more and cool the cell stacks more uniformly than in the comparative example in which the refrigerant flows from the first end to the second end for both the cooling pipe CP1 for cooling the cell stack CS1 and the cooling pipe CP2 for cooling the cell stack CS2 in parallel with each other.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A battery comprising:
a first cell stack and a second cell stack arranged side by side; and
a first cooling pipe and a second cooling pipe provided below the first and second cell stacks, respectively, and configured to cool the first and second cell stacks, respectively, wherein
the first and second cooling pipes extend from first ends of the first and second cell stacks to second ends thereof, respectively, and are connected to each other at the second ends,
an inlet port and an outlet port for a refrigerant flowing through the first and second cooling pipes are both provided at the first ends, and
the refrigerant flowing in from the inlet port first passes through the first cooling pipe from the first end, then passes through the second cooling pipe from the second end, and flows out from the outlet port.

2. The battery according to claim 1, wherein
in each of the first and second cell stacks, a plurality of rectangular cells are stacked on one another,
terminals are provided on both end faces in a longitudinal direction of each of the plurality of rectangular cells,
a pair of first cooling pipes are provided at both ends in a width direction of the first cell stack, and
a pair of second cooling pipes are provided at both ends in a width direction of the second cell stack.

3. The battery according to claim 2, wherein each of the pair of first cooling pipes and the pair of second cooling pipes is formed so as to extend from the first end to the second end, from the second end to the first end, and then from the first end to the second end again so as to form a Z-shape between the first and second ends.

4. The battery according to claim 3, wherein
in each of the pair of first cooling pipes, the refrigerant flows from an end in a width direction of the first cell stack toward a center thereof, and
in each of the pair of second cooling pipes, the refrigerant flows from an end in a width direction of the second cell stack toward a center thereof.

5. The battery according to claim 1, further comprising a plurality of first cell stacks and a plurality of second cell stacks.

6. The battery according to claim 5, where the numbers of the first and second cell stacks are equal to each other.

7. The battery according to claim 1, further comprising a case configured to house the first and second cell stacks, wherein
the first and second cooling pipes are disposed below a bottom plate of the case.
